(19) United States
(12) Patent Application Publication
(10) Pub. No.: US 2006/0075225 A1
(43) Pub. Date: Apr. 6, 2006

(54) Digital content protection for peer to peer networks

(76) Inventors: James P. Flynn, Northampton, MA (US); William D. Clarke, Florence, MA (US)

Correspondence Address: OLYMPIC PATENT WORKS PLLC, P.O. BOX 4277, SEATTLE, WA, 98104, US

(21) Appl. No.: 11/172,391

(22) Filed: Jun. 29, 2005

Related U.S. Application Data
(60) Provisional application No. 60/584,425, filed on Jun. 30, 2004.

(51) Int. Cl. H04L 9/00

(52) U.S. Cl. 713/165

(57) ABSTRACT

Method and system of the present invention provide for distribution of content (e.g. videos, games, music, etc.) via peer-to-peer (P2P) network, while ensuring that the content is not usable until it is purchased or rented. Methods and systems of the present invention deliver content over the Internet. One system embodiment includes an Internet-based service and client software that runs on customers' computers. To achieve increased efficiency and scalability, the present invention can deliver content to customers' computers by using peer to peer (P2P) networking. In that way, clients are also potential servers to other clients.

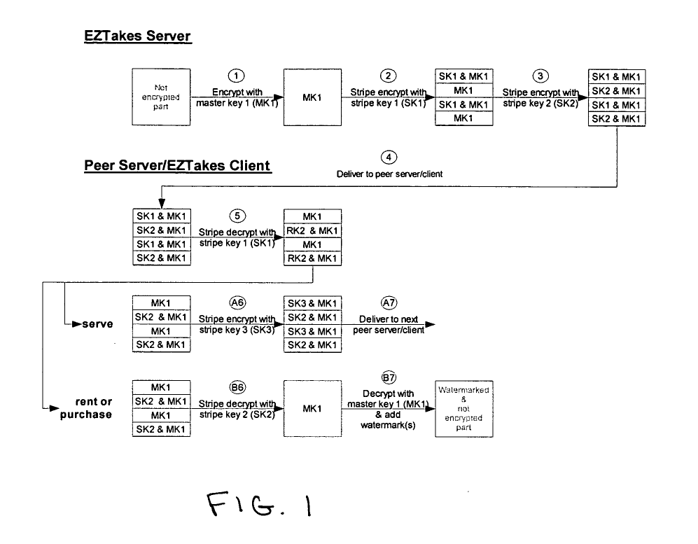

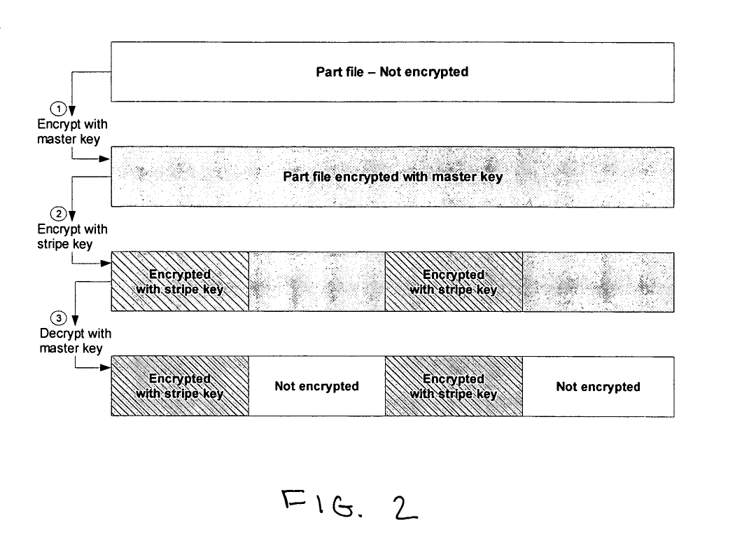

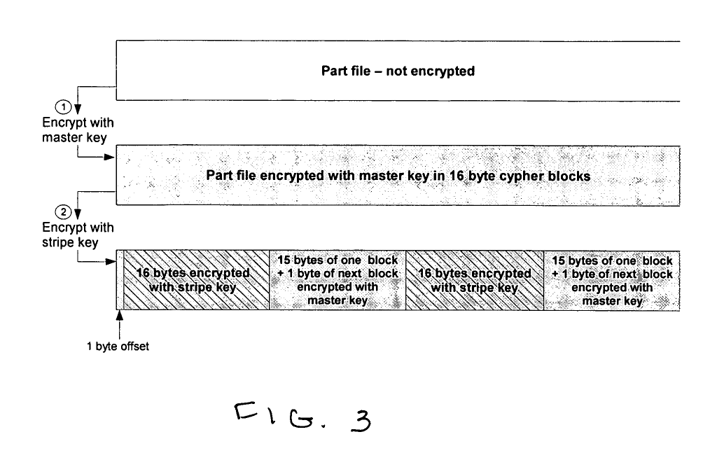

### CROSS-REFERENCE TO RELATED APPLICATION

This application claims the benefit of Provisional Application No. 60/584,425, filed Jun. 30, 2004.

### BACKGROUND OF THE INVENTION

This document describes the digital content protection techniques developed by Artio Systems, Inc. for use with its EZTakes service. The objective of the EZTakes content protection technology is to make it possible to distribute content (e.g. videos, games, music, etc.) via a peer-to-peer (P2P) network, while ensuring that the content is not usable until it is purchased or rented. This capability is likely to be important to any commercial application that seeks to deliver commercial content over a P2P network. The techniques described in this document are designed to minimize the possibility of a catastrophic breach. Such a breach, for example, could be a situation that results in a significant amount of content becoming easily-accessible without users first having to purchase or rent the content.

EZTakes delivers content over the Internet. It includes an Internet-based service and client software that runs on customers' computers. To achieve increased efficiency and scalability, EZTakes can deliver content to customers' computers by using peer to peer (P2P) networking. In that way, all EZTakes clients are also potential servers to other clients. When an EZTakes client serves content to other EZTakes clients, it is acting as a peer server. EZTakes may also leverage third party content delivery networks, such Akamai, in order to improve the speed and efficiency of the content delivery process.

The EZTakes client software downloads large digital content files in segments, or parts. For example, a 5 gigabyte movie file could be segmented into 50 parts of 100 megabytes each. Since multiple parts can be downloaded simultaneously, it is possible to significantly reduce the time it takes to obtain an entire content file, such as a feature-length movie, by initiating multiple downloads at the same time.

The EZTakes software employs encryption algorithms to protect content. The current EZTakes implementation, which is in testing as of the date of this writing, utilizes the Advanced Encryption Standard (AES) with 128 bit keys. It is important to note, however, that the content protection techniques described in this document are encryption algorithm-independent, and therefore could be used with many different encryption algorithms. The following diagram illustrates how encryption technology is employed to protect EZTakes content.

Diagram 1—EZTakes Content Protection Illustration

As shown in the upper left-hand corner of Diagram 1, the process begins with a part of a content file that is not encrypted and, therefore, is potentially playable by an appropriate device or software application. In step 1, the part is encrypted with a master key, MK1, which is utilized by an encryption algorithm in order to encrypt the data in the file. In step 2, the part is encrypted again with a stripe key, SK1. An EZTakes stripe key can be the same type of key as the master key, however, it gets its name because it is only used to encrypt alternating data blocks, or stripes, of the part file. The stripe key could, for example, be used to encrypt every other kilobyte or megabyte of the part file. In step 3, the data blocks of the part file that were not encrypted with SK1 are encrypted with a second stripe key, SK2. The result is a file that has been fully encrypted with MK1 and then stripe encrypted with SK1 and SK2. At that point the file is ready to be served to clients on the EZTakes network, which occurs in step 4.

After a client receives a part, it may serve the part to other peer servers or clients. If the customer decides to purchase or rent the content, then the part will also be decrypted along with other parts in order to create a complete content file. In order to take any of these actions, however, first the client must stripe decrypt the part by using SK1, which is shown as step 5. The peer server must retrieve SK1 from the main EZTakes server in order to perform the decryption. While Diagram 1 indicates that stripe decrypting may occur automatically upon receipt of the part, it is also possible to not stripe decrypt until it is necessary in order to serve the content to other clients, or when the client rents or purchases the content. That way, keys would not be provided by the EZTakes main server until they are absolutely required (also see section entitled Key Control Issues).

If the peer server is serving the part to other peer servers/clients on the EZTakes network, it must first stripe encrypt the part by using another stripe key, SK3, which would be provided by the EZTakes server. The step is shown as step A6.

If the customer decides to purchase or rent the content, then the customer must first confirm the transaction, which typically would require a corresponding customer payment (not shown). Then the EZTakes client must stripe decrypt the part with SK2, which results in a part file that is encrypted with MK1, as shown in step B6. Next, the main EZTakes server must provide MK1 to the client so that the client can fully decrypt the part, as shown completing in step B6. The client then combines the part with other parts to create a playable content file. Optionally, the content may also be digitally watermarked at the same time that it is fully decrypted. Watermarking is not required for content protection; however, it is useful for forensic tracking, which would enable a content owner to identify the responsible party, should content be used for illicit purposes, such as distribution on an illegal file sharing network. It is also worth noting that only the final full content file would have to be watermarked, not necessarily every part.

By using master and stripe key combinations, the probability of catastrophic breaches are greatly reduced. For example, even if a master key is published, content parts cannot be decrypted into a fully usable form by other EZTakes clients since each client will also require a stripe key to decrypt the part. Furthermore, in order to decrypt an entire content file, many different master keys and client-specific stripe keys are required.

While the content protection technique described in this document minimize the possibility of a catastrophic breach, there are some possible breaches that could occur if multiple EZTakes clients (or programs that spoof EZTakes clients) are able to intercept decryption keys. Referring to the Diagram 1 in the preceding section, a client could, for example, intercept both SK1 and then intercept MK1 during a purchase/rental transaction. The client could then pass both of these keys to the peer server that originally passed the protected part file to it. The peer server that passed the part could use these keys to unlock the part without anyone paying for the transaction. Since the master key is now known, and each client could potentially also capture the stripe key needed by the passing peer server, these keys could be passed recursively to all passing peer servers, which in turn, will enable those peer servers to unlock the corresponding parts. If a group of peers servers (or spoofing programs) could collude to pass the required keys to each other, it is possible that enough keys could be collected to unlock a content file for a peer server and all passing peer servers. The potential damage (i.e. revenue loss from content piracy) of this type of breach would be limited since it would likely be perpetrated by only a small number of high-motivated attackers. Moreover, it is unlikely that a large number of people would undertake such an effort in order to avoid paying a few dollars for a rental fee.

EZTakes, does, however, employ measures to minimize the probability of such a breach from happening by controlling how content parts are distributed through the EZTakes peer network. Under normal circumstances, EZTakes clients download parts from the peer network by selecting the best peer server from a list of available servers. The selected peer server is typically chosen for efficiency reasons. In other words, it can deliver parts to the requesting client faster than other available peer serves. It is important to note, however, that the main EZTakes service, (1) controls the list of available peer servers that the requesting client has to choose from; and (2) must setup a download session between requesting clients and peer servers (the EZTakes software will not respond to a download request unless specifically authorized by the main EZTakes server). Consequently, the main EZTakes server can greatly reduce the likelihood of the breach described in this section by ensuring the diversity of sources from which clients download parts. Clients can be prevented, for example, from downloading all parts from the same peer server, or even forced by the main EZTakes server to download parts from a wide variety of peer servers.

It is also important to mention that, when transmitting keys over a network, the keys should only be passed over a secure communications channel, such as Secure Sockets Layer (SSL). Even when keys are read into program memory by software, the keys should be overwritten quickly in order to make it extremely difficult for computer memory viewers to help discover the keys.

There are a number of options for modifying the digital content protection technique described in this document. These changes could have an impact on the security of the system.

The digital content protection techniques described in this documented could potentially be made stronger by stripe encrypting with an offset. Without an offset, it could be possible to partially decrypt a content part file, provided the corresponding master key is obtained, which is illustrated by the following diagram:

Diagram 2—Partial Decryption Using a Master Key

In the preceding diagram, the initial content part file, which is shown at the top of the diagram, is not encrypted. In step 1, the master key is applied by an algorithm to encrypt the file. In step 2, alternating data blocks, or stripes, are encrypted with a stripe key. In EZTakes, the part file shown after step 2 is ready to be served to requesting clients. The receiving clients will not be able to fully decrypt the part file unless they obtain both the master and stripe keys. A client could, however, decrypt parts of the file with the master key alone. While this is not a significant risk since the resultant partially-decrypted part file will not be particularly usable, it is an issue that could be addressed fairly easily by employing an offset, as illustrated in the following diagram.

Diagram 3—Using a Byte Offset Example

The process depicted in Diagram 3 is similar to Diagram 2, with an exception being that in step 2, instead of starting a stripe encryption at the beginning of the file, it starts at an offset, which can be as little as one byte in size.

The AES algorithm used by EZTakes belongs to category of encryption algorithms known as block cyphers since these types of algorithms encrypt data in fixed-sized blocks. AES uses 16-byte blocks. If a part file is stripe encrypted starting at an offset and the stripe size is equal to the cypher block size, then full cypher blocks would not be available. Consequently, none of the master key-encrypted stripes could be decrypted, even with the master key. When you stripe encrypt from an offset, you cannot decrypt anything using the master key unless you decrypt with the stripe key first.

It is important to note that when using an offset: (1) you should use a cypher block algorithm; and (2) the stripe size should be set to at least the same size as the cypher block size. If the master key-encrypted stripe size is larger than the cypher block size, then at least some of the stripes could be decrypted by using the master key.

Although it would eliminate virtually all the benefit of offsetting (see previous section), the stripe block sizes can be varied. For example, a stripe could be as small as 16 bytes, or as large as tens or even hundreds of megabytes. The stripe size selected could be determined based on performance of security criteria.

As shown in Diagram 1, parts are encrypted before being initially distributed by the EZTakes main server, which could also employ a third party content delivery network (CDN). Since how parts are distributed through the EZTakes peer network is controlled by the EZTakes main server, clients could be directed to download parts from the EZTakes main server instead of a peer-server. Each part served from the main EZTakes server could be encrypted by using a different master key. Consequently, even if a master key is obtained illicitly by a client, it is not likely to be the one that client needs to unlock the part file.

This document describes Artio's Digital Content Protection (DCP) technology, which makes it possible to deliver content over P2P networks while preventing unauthorized persons from accessing that content in a usable form. By using the techniques described in this document, content can be converted into a usable form only after a person obtains the proper authorization. Proper authorization can happen, for example, when the person that desires to access the content makes a payment for a rental or purchase of the content.

Artio's digital content protection technology minimizes the possibility of a catastrophic breach by making it extremely difficult for unauthorized persons to circumvent the protections that the Artio DCP provides, and by limiting the amount of content that can be made available, should a breach occur.

Glossary

This section includes many of the most important terms used in this document. Some of the terms are specific to EZTakes (e.g. stripe key), while others are industry standards.

Advanced Encryption Standard (AES)—An encryption standard set by the National Institute of Standards and Technology (NIST). In October 2000, NIST selected the Rijndael encryption formula to be incorporated into AES. That algorithm was developed by two Belgian cryptographers who have agreed that it may be used without royalty fees. It is a block cypher that employs fixed-sized blocks of 16 bytes each.

Block Cypher—A type of encryption algorithm that encrypts data in blocks. Blocks can sometimes be a fixed size, such as 16 bytes (or 128 bits).

Breach—Unauthorized use of the EZTakes system. It could result in a user accessing, or decrypting, content without paying the appropriate fee. It could also involve the corruption or unauthorized copying of system data.

Catastrophic breach—A breach that results in significant loss of revenue. This could occur due to widespread unauthorized use of content. It could also occur from malicious activity that might cause system downtime.

Content Delivery Network (CDN)—A service that enables more efficient delivery of data over a wide area network. This could include, for example, geographically distributed data servers that facility faster downloads by being closer to users. EZTakes is designed to be able to leverage peer networks; however, it could also utilize a CDN to replace or augment a peer-to-peer network.

Content—Movies, music, games, images and other works that users may wish to access in digital form.

Decryption—See Encryption/Decryption.

Decryption Key—See Encryption/Decryption Key.

Digital Content Protection—Measures aimed at preventing unauthorized use of content. EZTakes protects contet by using software and encryption algorithms. These measures are discussed in this document.

Digital Rights Management (DRM)—Technology that controls the access and use of digital content and digital assets. This could include software and hardware combinations that control the distribution, playback and payment for digital content on a highly granular level. The EZTakes content protection techniques described in this document could be considered a form of DRM; however, the EZTakes approach does not require new non-standard hardware devices. Furthermore, content distributed via EZTakes is typically only subject to similar usage terms as content purchased or rented on physical media, such as DVD.

Encryption—The process of scrambling information so that it is not usable without access to the appropriate decryption key. This process typically employs a standard encryption algorithm (see AES), as well as encryption/decryption keys. Symmetric algorithms employ the same key for encryption and decryption. Asymmetric algorithms employ different keys.

Encryption/Decryption Key—Data that, when used by the appropriate encryption algorithm, can be used to scramble or unscramble other data.

EZTakes Client—Software that users install on their personal computer that downloads content from the EZTakes network and enables the customer to rent and/or purchase the content, which unlocks the content into a playable format. The client also enables customers to burn content to portable media, such as DVD.

Forensic Tracking—The tracking of content that has been distributed in digital form. The personal digital watermarks employed by EZTakes, for example, make it possible to trace content found being used for illicit purposes (e.g. distribution over a file sharing network) back to the original renter.

Main EZTakes Server—The main controlling server, or servers, for the EZTakes service. It controls the distribution, tracking and protection of content on the EZTakes network.

Master Key—In EZTakes, a master key is used by the main EZTakes server (or content delivery servers) to encrypt content. The master key is the last key applied to decrypt content into a usable form.

Part—Segment of a content file. EZTakes breaks down content files, which can be very large, into smaller parts that can be downloaded simultaneously.

Peer Server—When an EZTakes client serves content to another EZTakes client, it is functioning as a peer server.

Peer-to-Peer (P2P)—A network of client computers that also act as servers to each other.

Requesting Client—A client on the EZTakes network that has requested content.

Stripe—A segment of a data file. Sometimes also referred to as a data block.

Stripe Key—In EZTakes, a stripe key is used to encrypt alternating data blocks, or stripes, of content. All appropriate stripe keys must be applied to decrypt content before applying the master key.

What is claimed:

1. A peer-to-peer content distribution system comprising:
a server that encrypts the content with a master encryption key, stripe encrypts portions of the content with two different stripe keys;
sever/clients that receive portions of the encrypted content from the server; and
clients that receive sufficient portions of the content from one or more of the server/clients
and server, along with decryption keys, to assemble and decrypt the content.
